(19) United States
(12) Patent Application Publication
(10) Pub. No.: US 2026/0228226 A1
(43) Pub. Date: Aug. 6, 2026

(54) LIGHTWEIGHT RETRIEVAL AUGMENTED GENERATION SYSTEMS AND METHODS

(71) Applicant: INTUIT INC., Mountain View, CA (US)

(72) Inventors: Idan HABLER, Tel Aviv (IL); Tsofit Efroni ZAZON, Tel Aviv (IL); Yael Mathov GOME, Tel Aviv (IL); Ron BITTON, Tel Aviv (IL)

(73) Assignee: INTUIT INC., Mountain View, CA (US)

(21) Appl. No.: 19/043,359

(22) Filed: Jan. 31, 2025

(51) Int. Cl. G06F 16/2457

(52) U.S. Cl. CPC G06F 16/2457

(57) ABSTRACT

At least one processor may provision a plurality of edge retrieval-augmented generation (RAG) datasets each containing a respective incomplete subset of a core RAG dataset and each being associated with a respective one of a plurality of user groups. The at least one processor may receive a request for processing using RAG from a user of one of the plurality of user groups. The at least one processor may process the request using the edge RAG dataset associated with the one of the plurality of user groups and provide a result of the processing to the user.

### BACKGROUND

Many large language models (LLMs) and other machine learning (ML) systems benefit from retrieval-augmented generation (RAG) methods whereby core training data can be enhanced by stored RAG data that provides context-specific information. RAG has brought significant advancements in deploying intelligent systems capable of providing contextual and relevant information to users. However, the efficiency and accuracy of information retrieval remain challenging in dynamic and diverse user environments. RAG deployment methods often fail to deliver optimal performance due to the variability in user queries and preferences, resulting in slower retrieval times and less relevant data outputs. RAG is hindered by a one-size-fits-all approach to information retrieval in diverse user environments. Users have distinct structures and prompt preferences, and a deployment strategy that overlooks these differences can lead to suboptimal results.

### BRIEF DESCRIPTIONS OF THE DRAWINGS

FIG. 1 shows an example lightweight RAG system according to some embodiments of the disclosure.

FIG. 2 shows an example lightweight RAG process according to some embodiments of the disclosure.

FIG. 3 shows an example user grouping process according to some embodiments of the disclosure.

FIG. 4 shows an example pre-fetching process according to some embodiments of the disclosure.

FIG. 5 shows an example deployment process according to some embodiments of the disclosure.

FIG. 6 shows an example RAG query handling process according to some embodiments of the disclosure.

FIG. 7 shows an example alignment process according to some embodiments of the disclosure.

FIG. 8 shows an example computing device according to some embodiments of the disclosure.

### DETAILED DESCRIPTION OF SEVERAL EMBODIMENTS

Systems and methods described herein may provide a tailored RAG deployment mechanism that can adapt to a variety of different (e.g., user-specific) requirements, ensuring faster and more accurate information retrieval. For example, systems and methods described herein may cluster users according to structural similarities and/or prompt preferences to deploy lightweight RAG datasets (“EdgeRAGs”) that may be pre-loaded with relevant information. This approach may enhance retrieval speed and accuracy by aligning the embedding space more closely with user profiles, preferences, and/or requirements.

In some embodiments, users may be clustered according to their structural similarities and prompt preferences, thereby identifying groups of users with similar information needs. For each identified cluster, an EdgeRAG may be built from relevant information pre-fetched from a central RAG database (“CoreRAG”) that may store a comprehensive repository of data. The EdgeRAGs may be deployed and, when a user of a given cluster requests RAG processing, RAG data may be obtained from the associated EdgeRAG. As a result, RAG data retrieval may be significantly faster and more accurate relative to systems wherein only a CoreRAG or its equivalent is used. The embedding space in the EdgeRAGS may be optimized to align closely with the user profiles, leading to more precise and contextually apt responses. Therefore, embodiments described herein can reduce computational overhead and network latency, optimizing the overall operational efficiency of a RAG system. In addition to these technical advantages, embodiments described herein may improve user satisfaction and retention and/or provide more personalized experiences to the user.

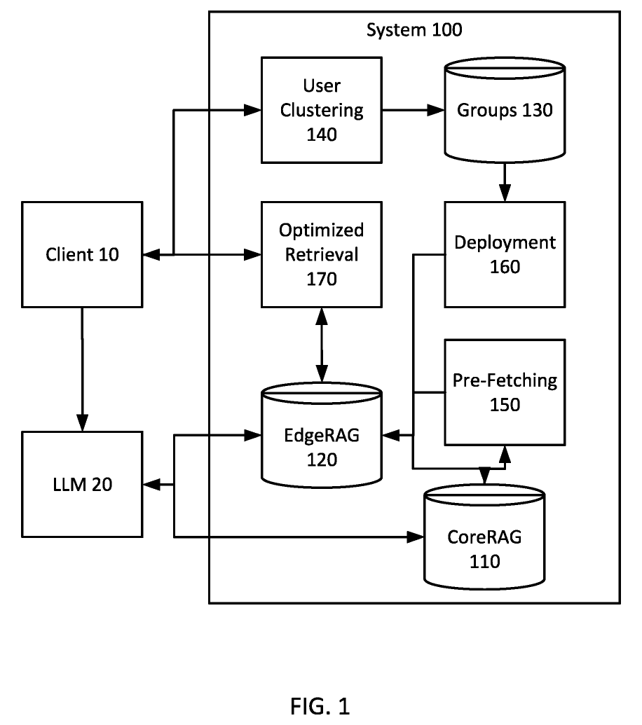

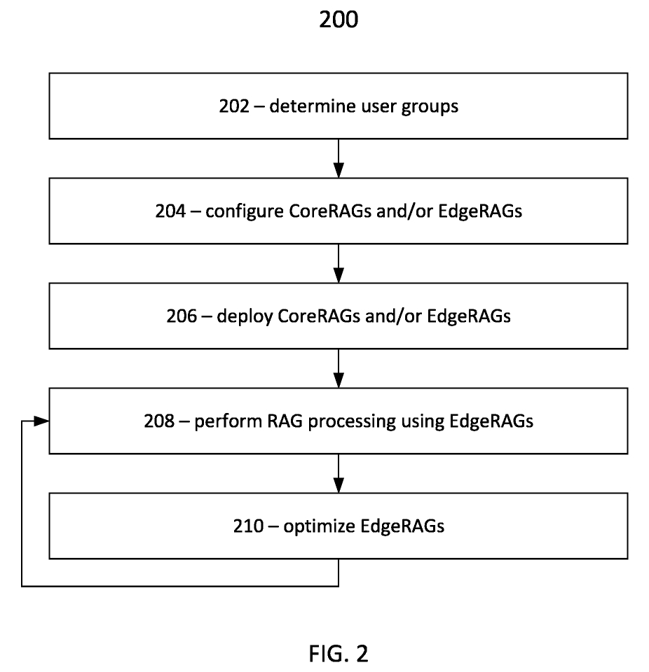

FIG. 1 shows an example lightweight RAG system 100 according to some embodiments of the disclosure. System 100 may include one or more modules and/or data stores such as CoreRAG 110, EdgeRAG 120, groups 130, user clustering 140, pre-fetching 150, deployment 160, and/or optimized retrieval 170. The elements of system 100 are described in greater detail below with respect to FIGS. 2-7, but in general, system 100 can form user groups, develop EdgeRAGs 120 for respective user groups, and, with LLM 20, process client 10 RAG processing requests using the EdgeRAGs 120.

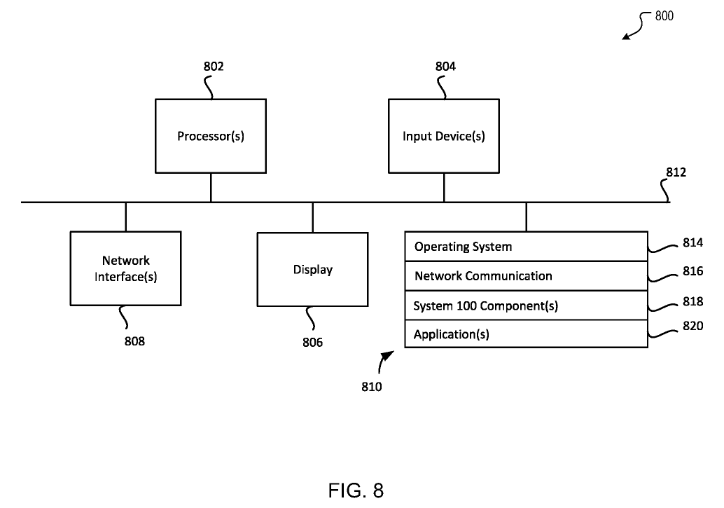

Illustrated components may include a variety of hardware, firmware, and/or software components that interact with one another. Some components shown in FIG. 1 may communicate with one another using networks. For example, system 100 may communicate with client 10 and/or LLM 20 through one or more networks (e.g., the Internet, an intranet, and/or one or more networks that provide a cloud environment). In some embodiments, elements of system 100 may communicate with one another through the one or more networks. For example, as described in detail below, EdgeRAGs 120 may be deployed throughout a network so that RAG processing requests by clients 10 can be processed by EdgeRAGs 120 without requiring communication to other system 100 components. Each component may be implemented by one or more computers (e.g., as described below with respect to FIG. 8).

Elements illustrated in FIG. 1 (e.g., system 100 (including CoreRAG 110, EdgeRAG 120, groups 130, user clustering 140, pre-fetching 150, deployment 160, and optimized retrieval 170). client 10, and/or LLM 20) are each depicted as single blocks for ease of illustration, but those of ordinary skill in the art will appreciate that these may be embodied in different forms for different implementations. For example, while separate modules of system 100 are depicted separately, any combination of these elements may be part of a combined hardware, firmware, and/or software element. Moreover, while the modules are depicted as parts of a single system 100 element, any combination of these elements may be distributed among multiple logical and/or physical locations. Also, while one client 10, one LLM 20, one CoreRAG 110, one EdgeRAG 120, one groups 130, one user clustering 140, one pre-fetching 150, one deployment 160, and one optimized retrieval 170 are illustrated, this is for clarity only, and multiples of any of the above elements may be present. In practice, there may be single instances or multiples of any of the illustrated elements, and/or these elements may be combined or co-located. For example, a plurality of clients 10 may be used by a plurality of users assembled into a plurality of groups 130. Separate EdgeRAGs 120 may be created for and used by the users of respective groups 130.

In the following descriptions of how the illustrated components function, several examples are presented. However, those of ordinary skill in the art will appreciate that these examples are merely for illustration, and the disclosed embodiments are extendable to other application and data contexts.

FIG. 2 shows an example lightweight RAG process 200 according to some embodiments of the disclosure. System 100 may perform process 200 to create and deploy EdgeRAGs 120, provide lightweight, targeted RAG processing, and continuously monitor and improve EdgeRAG 120 performance.

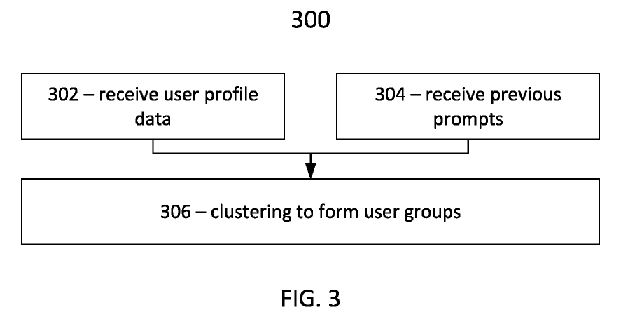

At 202, system 100 can determine user groups. In some embodiments, user clustering 140 may perform processing to define and store groups 130 using data originating at least in part from client 10 and/or interactions between users of client 10 and system 100. For example, user clustering 140 may determine at least one of the user groups by processing comprising generating user clusters according to at least one RAG request similarity. This can include, for example, processing, by at least one ML algorithm, at least one of a profile of the user and at least one previous request for processing from the user (e.g., at least one previous RAG processing request). This processing may identify RAG request similarities and/or user profile similarities. As an output of the processing, the ML algorithm may cluster the user into the one of the plurality of user groups, enabling subsequent processing in process 200 to determine that a user is associated with the one of the plurality of user groups. An example of determining user groups is discussed below with reference to FIG. 3.

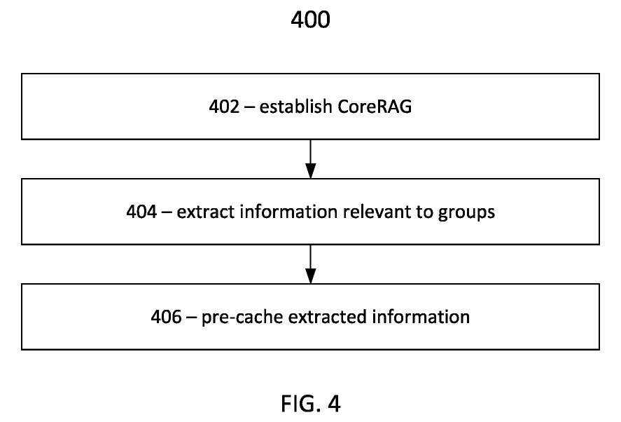

At 204, system 100 can configure CoreRAGs and/or EdgeRAGs. System 100 may configure CoreRAG 110 having comprehensive data that may be applicable to a wide variety of RAG requests. Pre-fetching 150 may extract incomplete subsets of CoreRAG 110 dataset relevant to one or more of the respective RAG request similarities determined at 202 and locally cache the extracted incomplete subset as one or more EdgeRAGs 120. For example, pre-fetching 150 may configure at least one of EdgeRAG 120 datasets by processing comprising aligning an embedding space of the at least one of the EdgeRAG 120 datasets with data describing the associated one of the plurality of user groups (e.g., at least one of user profile data and at least one previous request for processing from at least one user of the associated one of the plurality of user groups). An example of pre-fetching is discussed below with reference to FIG. 4.

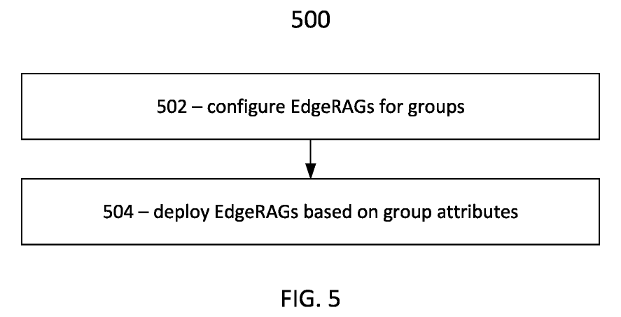

At 206, system 100 can deploy CoreRAG 110 and/or EdgeRAGs 120. For example, deployment 160 may configure each respective EdgeRAG 120 to receive user requests for processing using RAG from users of the respective user group and/or may configure CoreRAG 110 to receive such requests when EdgeRAG 120 does not have responsive information, as described below. In some cases, EdgeRAGs 120 may be deployed at “edges” of a network close to clients 10 frequently used by users of the associated user group. An example of deployment is discussed below with respect to FIG. 5.

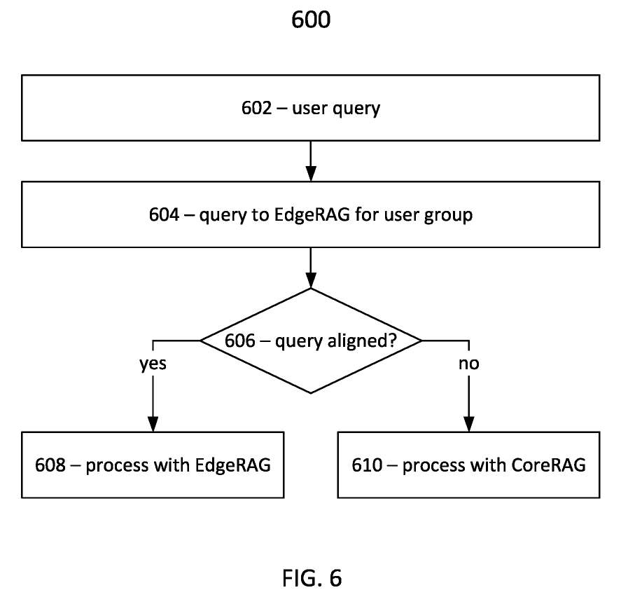

At 208, system 100 can perform RAG processing using one or more EdgeRAGs. For example, optimized retrieval 170 and/or EdgeRAG 120 may receive a request for processing using RAG from client 10 as used by a user of one of the plurality of user groups. The dataset associated with the one of the plurality of user groups may be used to process the request. For example, LLM 20 can use RAG data from EdgeRAG 120 to respond to a request from client 10 according to any known or proprietary LLM processing and/or prompting techniques and provide a result of the processing to the user of client 10. In some embodiments, this may include optimized retrieval 170 and/or EdgeRAG 120 determining a user group for the user, and therefore an appropriate EdgeRAG 120 to use, according to data in the request and/or profile data included with the request. In some cases, optimized retrieval 170 and/or EdgeRAG 120 may determine that all embeddings within a selected EdgeRAG 120 dataset fail to align with the request for processing and, accordingly, the request may be processed using the CoreRAG 110 dataset in response to the determining that all embeddings within the edge RAG dataset fail to align with the request for processing. An example of RAG processing is discussed below with reference to FIG. 6.

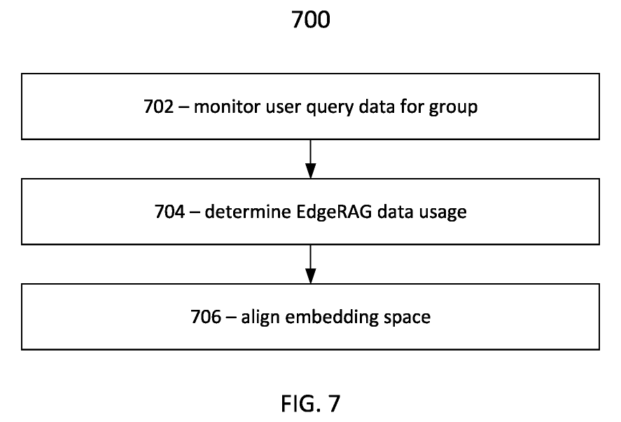

At 210, system 100 can optimize one or more EdgeRAGs 120. For example, optimized retrieval 170 may receive at least one of the user requests for processing using RAG and feedback on the processing using RAG (e.g., feedback indicating alignment or a lack of alignment between at least one of the EdgeRAG 120 datasets and at least one of the user requests for processing by the at least one EdgeRAG 120 dataset). In case of a lack of alignment indicated by the feedback, optimized retrieval 170, deployment 160, and/or pre-fetching 150 may modify content of the unaligned EdgeRAG 120 dataset, for example by adding content from CoreRAG 110 to EdgeRAG 120 and/or removing unused content from EdgeRAG 120. An example of optimization is discussed below with respect to FIG. 7.

FIG. 3 shows an example user grouping process 300 according to some embodiments of the disclosure. For example, system 100 (e.g., user clustering 140) may perform process 300 at 202 of process 200 to determine user groups and/or place users within groups of like users.

At 302, system 100 can receive user profile data. For example, RAG processing may be offered to users of a product or service. As a non-limiting example, a user interface for a tax software platform or an accounting software platform may have a built-in chat feature through which a user can prompt LLM 20, for example to ask questions about taxes or accounting and/or the ways in which the software platform can assist the user. Because such questions are domain-specific, being focused on tax or accounting, general-purpose LLM 20 may benefit from RAG. Furthermore, if the user is registered with the software platform itself, for example through creation of a user account and/or formation of a record of activity within the software platform, user-specific data (e.g., user profile data such as demographic information) may be available to help define user needs and/or preferences. In some embodiments, user clustering 140 may obtain some or all of this user profile data.

At 304, system 100 can receive previous prompts. Continuing the software platform with chat interface example, the user may have used the chat interface to create prompts in the past. As with the user profile data, previous prompt data may be useful in determining user needs and/or preferences. The software platform may store a record of such interactions and/or a context in which the user used the chat interface (e.g., within what portion of the user interface, at what stage of processing, etc.). In some embodiments, user clustering 140 may obtain some or all of this record data.

At 306, system 100 can perform clustering processing to form user groups. For example, user clustering 140 may use one or more ML algorithms to measure similarities among users (e.g., cosine similarity and/or hierarchical clustering). User clustering 140 may group users into clusters based on calculated similarity scores, each of which may represent similar RAG retrieval needs among members of the cluster. For example, users having similar taxable assets, income levels, and/or other factors may frequently ask similar questions, and accordingly user clustering 140 may group users with similar tax situations into the same group. Likewise, users having similar roles within organizations may have similar needs to access similar data, and user clustering 140 may therefore group them into the same group so that they can access the data in one RAG repository (e.g., the associated EdgeRAG 120).

As an example, CoreRAG 110 may store a variety of document types that may be relevant, or not relevant, for different groups of users. For the purposes of illustration, document types stored in a CoreRAG 110 of an organization may include income tax returns, W-2s, 1099s, tax deduction proofs, property tax statements, quarterly estimated tax payment receipts, employee contracts, payroll records, performance appraisals, employee benefits information, and/or leave records. Among others, organization users may include tax professionals and human resources professionals. Using user profile data and/or past usage history data, user clustering 140 may cluster the tax professionals into a first group and the human resources professionals into a second group. As described in detail below, the first group may be linked to an EdgeRAG 120 with one subset of the CoreRAG 110 documents, and the second group may be linked to an EdgeRAG 120 with another subset of the CoreRAG 110 documents.

FIG. 4 shows an example pre-fetching process 400 according to some embodiments of the disclosure. For example, system 100 (e.g., pre-fetching 150) may perform process 400 at 204 of process 200 to configure CoreRAG 110 and/or extract data from CoreRAG 110 for use in one or more EdgeRAGS 120.

At 402, system 100 can establish CoreRAG 110. CoreRAG 110 may be configured to include a comprehensive dataset for all anticipated RAG needs of system 100 in some embodiments. For example, assuming system 100 is configuring RAG for a software platform dedicated to tax filing, CoreRAG 110 may include a comprehensive tax data set that LLM 20 may use to answer questions by users throughout the tax filing process, regardless of user profile and/or specific tax issue. CoreRAG 110 may therefore be a large dataset with general applicability.

At 404, system 100 can extract information relevant to one or more groups. In some embodiments, experts may contribute domain knowledge to manually curate extracted subsets of CoreRAG 110 data per cluster. In some embodiments, clusters may be formed (e.g., by performing process 300), prompts by the users of a cluster may go to CoreRAG 110, and pre-fetching 150 may monitor this activity to determine what data within CoreRAG 110 is frequently used by the users of the cluster. Given time to perform such monitoring, pre-fetching 150 may automatically identify information to extract.

For example, consider the case where a group of tax professionals and a group of human resources professionals have been identified, and CoreRAG 110 includes income tax returns, W-2s, 1099s, tax deduction proofs, property tax statements, quarterly estimated tax payment receipts, employee contracts, payroll records, performance appraisals, employee benefits information, and/or leave records. System 100 can extract income tax returns, W-2s, 1099s, tax deduction proofs, property tax statements, and/or quarterly estimated tax payment receipts as a first subset of data relevant to the tax professionals. System 100 can extract employee contracts, payroll records, performance appraisals, employee benefits information, and/or leave records as a second subset of data relevant to the human resources professionals.

At 406, system 100 can pre-cache information extracted at 404. For example, pre-fetching 140 may deliver pre-processed, contextually pertinent data from CoreRAG 110 to local caches dedicated to each cluster. In some embodiments, pre-fetching 140 may perform known and/or proprietary processing to configure a RAG database containing pre-cached data for a given cluster. Accordingly, pre-fetching 140 may build EdgeRAG 120 for a cluster as a vector database or other database that may be linked to and/or otherwise accessible and/or searchable by LLM 20.

FIG. 5 shows an example deployment process 500 according to some embodiments of the disclosure. For example, system 100 (e.g., deployment 160) may perform process 500 at 206 of process 200 to deploy EdgeRAGs 120 so that they may be used to perform RAG processing in response to user requests.

At 502, system 100 can configure EdgeRAGs 120 for each of the groups. Using the pre-cached information and user information both obtained and/or generated as described above, deployment 160 may link each cluster of users to its respective EdgeRAG 120. Thus, as described below, when a user requests RAG processing, system 100 may use identifying information of the user to select the appropriate EdgeRAG 120 to which the request should be routed.

At 504, system 100 can deploy EdgeRAGs 120 configured at 502 based on group attributes. For example, deployment 160 may designate EdgeRAGs 120 configured as described above as active and/or may otherwise make them available for use. This may include instantiating EdgeRAGs 120 physically within a network. In some cases, such as when the cluster has a geographic component to its constituent user membership or other characteristic suggesting a specific location for EdgeRAG 120 deployment, deployment 160 may deploy EdgeRAG 120 in a location physically near and/or otherwise conveniently network-accessibly to the cluster’s users to the extent possible.

FIG. 6 shows an example RAG query handling process 600 according to some embodiments of the disclosure. For example, system 100 (e.g., optimized retrieval 170, EdgeRAG 120, and/or other components thereof) and/or LLM 20 may perform process 600 at 208 of process 200 to respond to user queries using EdgeRAGs 120, thereby providing targeted, efficient, and responsive RAG-augmented LLM processing.

At 602, system 100 and/or LLM 20 can receive a user query. For example, a user of client 10 may ask a question of a chat bot in a software product user interface as described above. In some embodiments, system 100 and LLM 20 may both receive the question from client 10. In other embodiments, the question may go to LLM 20 (e.g., as part of, or as an entire, prompt).

At 604, system 100 and/or LLM 20 can send the query to EdgeRAG 120 of the user’s group. For example, a system prompt used by LLM 20 may direct LLM 20 to obtain RAG data from system 100. Accordingly, LLM 20 may use user-identifying information to select the EdgeRAG 120 to access that is linked to the user (e.g., by deployment 160 as described above). For example, a user registered as a tax professional may be linked to an EdgeRAG 120 storing the set of documents relevant to tax professionals, and/or a user registered as a human resources professional may be linked to an EdgeRAG 120 storing the set of documents relevant to human resources professionals.

At 606, system 100 can determine whether the query is aligned with EdgeRAG 120. For example, LLM 20 may query the vector database of EdgeRAG 120 using the query and receive a response indicating one or more vector contents of EdgeRAG 120 and respective percent match or other match scores for each of the contents. The query may be deemed aligned if the match score is above some threshold value (e.g., 50%, 75%, or any other threshold according to design choice).

At 608, if the query is aligned, system 100 can process the query using EdgeRAG 120. In this case, LLM 20 may use a most closely aligned entry within EdgeRAG 120 to generate an LLM response using any LLM and/or RAG processing technique, for example. At 610, if the query is not aligned, system 100 can process the query using CoreRAG 110. If no entries in EdgeRAG 120 are above the threshold, the query may be passed to CoreRAG 110, and LLM 20 may use a most closely aligned entry within CoreRAG 110 to generate an LLM response using any LLM and/or RAG processing technique. In some embodiments, if a user’s queries repeatedly cause calls to CoreRAG 110, system 100 may assign the user to be analyzed and possibly placed in a different user cluster (e.g., by process 300).

FIG. 7 shows an example alignment process 700 according to some embodiments of the disclosure. For example, system 100 (e.g., optimized retrieval 170) may perform process 700 at 210 of process 200 to ensure and/or improve the relevance of EdgeRAG 120 data to the cluster of users it serves.

At 702, system 100 can monitor user query data for a group. For example, optimized retrieval 170 (or other components of system 100), client 10, and/or LLM 20 may maintain a record of queries made to LLM 20. As these queries may have user identifying data within and/or included therewith (e.g., as user ID data, IP data, metadata, etc.), optimized retrieval 170 may gather and store these query records by user group.

At 704, system 100 can determine EdgeRAG 120 data usage. For example, EdgeRAG 120 (or other components of system 100) and/or LLM 20 may maintain a record of data sent from EdgeRAG 120 to LLM 20 for use in RAG-augmented LLM processing by LLM 20. Optimized retrieval 170 may correlate the data sent from EdgeRAG 120 to LLM 20 with the user query data (e.g., by timestamp, by user identifying data included in and/or with the messages sent to LLM 20 from EdgeRAG 120 and/or from LLM 20 to EdgeRAG 120). Accordingly, optimized retrieval 170 may have a record of user queries made by a cluster and EdgeRAG 120 data used by a cluster.

At 706, system 100 can align the embedding space of EdgeRAG 120. For example, optimized retrieval 170 may check the user query data from 702 against the data contained in EdgeRAG 120 (e.g., determine vector alignment of the user query data with the data contained in EdgeRAG 120 for embodiments wherein EdgeRAG 120 is a vector database) and/or may identify frequent (e.g., multiple instances) queries where LLM 20 had to obtain data from CoreRAG 110 due to a lack of alignment in EdgeRAG 20 as described above. To the extent there are frequent queries that do not align with the data contained in EdgeRAG 120, optimized retrieval 170 may add the data from CoreRAG 110 that does align with the frequent queries to EdgeRAG 120. Optimized retrieval 170 may also identify data in EdgeRAG 120 that has never been accessed by LLM 20 and/or that has not been accessed more recently than some threshold time and remove such data from EdgeRAG 120.

FIG. 8 shows a computing device 800 according to some embodiments of the disclosure. For example, computing device 800 may function as system 100 and/or any portion(s) thereof, or multiple computing devices 800 may function as system 100 and/or any portion(s) thereof.

Computing device 800 may be implemented on any electronic device that runs software applications derived from compiled instructions, including without limitation personal computers, servers, smart phones, media players, electronic tablets, game consoles, email devices, etc. In some implementations, computing device 800 may include one or more processors 802, one or more input devices 804, one or more display devices 806, one or more network interfaces 808, and one or more computer-readable mediums 810. Each of these components may be coupled by bus 812, and in some embodiments, these components may be distributed among multiple physical locations and coupled by a network.

Display device 806 may be any known display technology, including but not limited to display devices using Liquid Crystal Display (LCD) or Light Emitting Diode (LED) technology. Processor(s) 802 may use any known processor technology, including but not limited to graphics processors and multi-core processors. Input device 804 may be any known input device technology, including but not limited to a keyboard (including a virtual keyboard), mouse, track ball, and touch-sensitive pad or display. Bus 812 may be any known internal or external bus technology, including but not limited to ISA, EISA, PCI, PCI Express, NuBus, USB, Serial ATA or FireWire. In some embodiments, some or all devices shown as coupled by bus 812 may not be coupled to one another by a physical bus, but by a network connection, for example. Computer-readable medium 810 may be any medium that participates in providing instructions to processor(s) 802 for execution, including without limitation, non-volatile storage media (e.g., optical disks, magnetic disks, flash drives, etc.), or volatile media (e.g., SDRAM, ROM, etc.).

Computer-readable medium 810 may include various instructions 814 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 804; sending output to display device 806; keeping track of files and directories on computer-readable medium 810; controlling peripheral devices (e.g., disk drives, printers, etc.) which can be controlled directly or through an I/O controller; and managing traffic on bus 812. Network communications instructions 816 may establish and maintain network connections (e.g., software for implementing communication protocols, such as TCP/IP, HTTP, Ethernet, telephony, etc.).

System 100 components 818 may include instructions for performing the processing described herein. For example, system 100 components 818 may provide instructions for performing any and/or all of processes 200-700, and/or other processing as described above. Application(s) 820 may be an application that uses or implements the outcome of processes described herein and/or other processes. In some embodiments, the various processes may also be implemented in operating system 814.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In some cases, instructions, as a whole or in part, may be in the form of prompts given to a large language model or other machine learning and/or artificial intelligence system. As those of ordinary skill in the art will appreciate, instructions in the form of prompts configure the system being prompted to perform a certain task programmatically. Even if the program is non-deterministic in nature, it is still a program being executed by a machine. As such, “prompt engineering” to configure prompts to achieve a desired computing result is considered herein as a form of implementing the described features by a computer program.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API and/or SDK, in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs can include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language "means for" or "step for" be interpreted under 35 U.S.C. 112(f). Claims that do not expressly include the phrase "means for" or "step for" are not to be interpreted under 35 U.S.C. 112(f).

What is claimed is:

1. A method comprising:
provisioning, by at least one processor, a plurality of edge retrieval-augmented generation (RAG) datasets each containing a respective incomplete subset of a core RAG dataset, the provisioning comprising, for each respective edge RAG dataset, aligning an embedding space of the core RAG dataset corresponding to the respective incomplete subset with a respective one of a plurality of user groups and storing the respective edge RAG dataset independently of the core RAG dataset and other edge RAG datasets;
receiving, by at least one processor, a request for processing using RAG from a user;
determining, by the at least one processor, one of the plurality of user groups to which the user belongs;
selecting, by the at least one processor, an edge RAG dataset aligned with the one of the user groups to which the user belongs from among the plurality of edge RAG datasets;
processing, by the at least one processor, the request using the selected edge RAG dataset; and providing, by the at least one processor, a result of the processing to the user.

2. The method of claim 1, wherein at least one of the user groups is determined by processing comprising generating user clusters according to at least one RAG request similarity.

3. The method of claim 1, further comprising determining, by the at least one processor, that the user is associated with the one of the plurality of user groups.

4. The method of claim 3, wherein the determining comprises processing, by at least one machine learning algorithm, at least one of a profile of the user and at least one previous request for processing from the user, wherein as an output of the Page 2
processing, the machine learning algorithm clusters the user into the one of the plurality of user groups.

5. The method of claim 1, wherein at least one of the edge RAG datasets is configured by processing comprising aligning an embedding space of the at least one of the edge RAG datasets with data describing the associated one of the plurality of user groups.

6. The method of claim 5, wherein the data describing the associated one of the plurality of user groups includes at least one of user profile data and at least one previous request for processing from at least one user of the associated one of the plurality of user groups.

7. The method of claim 1, wherein the processing comprises: determining that all embeddings within the edge RAG dataset fail to align with the request for processing; and processing the request using the core RAG dataset in response to the determining that all embeddings within the edge RAG dataset fail to align with the request for processing.

8. A method comprising:receiving, by at least one processor, a request from a user for processing using retrieval-augmented generation (RAG) and profile data of the user;determining, by the at least one processor, a user group to which the user belongs from among a plurality of user groups according to the profile data;selecting, by the at least one processor, an edge RAG dataset aligned with the one of the user groups to which the user belongsthat is one of a plurality of available edge RAG datasets, each of the available edge RAG datasets containing a respective incomplete subset of a core RAG dataset, each respective incomplete subset having a corresponding
embedding space of the core RAG dataset aligned with a respective one of a plurality of user groups, and each respective edge RAG dataset being stored independently of the core RAG dataset and other edge RAG datasets;processing, by the at least one processor, the request using the selected edge RAG dataset;andproviding, by the at least one processor, a result of the processing to the user.

9. The method of claim 8, wherein at least one of the user groups is determined by processing comprising generating user clusters according to at least one RAG request similarity.

10. The method of claim 8, wherein the determining comprises processing, by at least one machine learning algorithm, at least one of the profile data and at least one previous request for processing from the user, wherein as an output of the processing, the machine learning algorithm clusters the user into the one of the plurality of user groups.

11. The method of claim 8, wherein at least one of the edge RAG datasets is configured by processing comprising aligning an embedding space of the at least one of the edge RAG datasets with data describing the associated one of the plurality of user groups.

12. The method of claim 11, wherein the data describing the associated one of the plurality of user groups includes at least one of user profile data and at least one previous request for processing from at least one user of the associated one of the plurality of user groups.

13. The method of claim 8, further comprising:determining that all embeddings within the edge RAG dataset fail to align with the request for processing; and
processing the request using the core RAG dataset in response to the determining that all embeddings within the edge RAG dataset fail to align with the request for processing.

14. A method comprising:receiving, by at least one processor, user interaction data for a plurality of users;grouping, by the at least one processor, the plurality of users into a plurality of user groups according to user interaction data similarity;configuring, by the at least one processor, a respective edge retrieval-augmented generation (RAG) dataset for each of the plurality of user groups, the configuring comprising, for each respective edge RAG dataset, aligning an embedding space of the core RAG dataset corresponding to a respective incomplete subset of a core RAG dataset with the user interaction data of the respective user group and storing the respective edge RAG dataset independently of the core RAG dataset and other edge RAG datasets; anddeploying, by the at least one processor, the respective edge RAG datasets for each of the plurality of user groups, the deploying comprising configuring each respective edge RAG dataset to receive user requests for processing using RAG from users of the respective user group upon determination that a user generating the request belongs to the respective user group.

15. The method of claim 14, wherein the grouping includes: processing, by at least one machine learning algorithm, the user interaction data to identify a plurality of RAG request similarities; and forming the plurality of user groups as clusters respectively sharing one or more of the respective RAG request similarities.

16. The method of claim 15, wherein the configuring includes:extracting the incomplete subset of the core RAG dataset relevant to the one or more of the respective RAG request similarities; and
